(19) United States
(12) Patent Application Publication
(10) Pub. No.: US 2017/0268735 A1
(43) Pub. Date: Sep. 21, 2017

(54) Skewed Luminaire Housing

(71) Applicants: Oliver Ernst, Peachtree City, GA (US); Russell Green, Douglasville, GA (US); Grzegorz Wronski, Peachtree City, GA (US)

(72) Inventors: Oliver Ernst, Peachtree City, GA (US); Russell Green, Douglasville, GA (US); Grzegorz Wronski, Peachtree City, GA (US)

(21) Appl. No.: 14/920,774

(22) Filed: Oct. 22, 2015

Related U.S. Application Data
(60) Provisional application No. 62/069,978, filed on Oct. 29, 2014.

(51) Int. Cl. F21S 8/02; F21V 14/02; F21V 19/02

(52) U.S. Cl. CPC F21S 8/026; F21V 19/02; F21V 14/02

(57) ABSTRACT

A housing for a recessed lighting fixture includes a can having an opening for passage of light out of the can and a can top attached to the can. The can top and the opening are at opposite ends of the can. The can and the can top define a cavity of the housing. A front section of the can and a rear section of the can are each skewed between the opening and the can top.

### RELATED APPLICATIONS

The present application claims priority to U.S. Provisional Patent Application No. 62/069,978, titled “Curved Luminaire Housing” and filed on Oct. 29, 2014, the entire content of which is incorporated herein by reference.

### TECHNICAL FIELD

The present disclosure relates generally to lighting fixtures, and more particularly to a skewed housing for recess installation in a sloped ceiling or a similar structure.

### BACKGROUND

A recessed lighting fixture may sometimes be installed in a sloped ceiling. Installing a typical recessed lighting fixture that is not designed for sloped ceilings may result in light from the lighting fixture being focused at an angle that is not perpendicular to the floor below the sloped ceiling. For example, a lighting fixture that is recessed in a sloped ceiling may provide uneven illumination relative to the different sides of the lighting fixture. To remedy the issue of uneven illumination that may result from recessed installation in a sloped ceiling, some recessed lighting fixtures may allow the orientation of the light source of the lighting fixture to be adjusted. However, due to various limitations such as lighting fixture housing designs, common existing recessed lighting fixtures are generally limited for use with sloped ceilings having a pitch in the range of 2/12 to 6/12 or in the range of 7/12 to 12/12.

Thus, a lighting fixture that can be recessed in sloped ceilings having pitch ranges wider than the pitch ranges supported by existing recessed lighting fixtures is desirable.

### SUMMARY

The present disclosure relates generally to lighting fixtures, and more particularly to a skewed housing for recess installation in a sloped ceiling or a similar structure. In an example embodiment, a housing for a recessed lighting fixture includes a can having an opening for passage of light out of the can and a can top attached to the can. The can top and the opening are at opposite ends of the can. The can and the can top define a cavity of the housing. A front section of the can and a rear section of the can are each skewed between the opening and the can top.

In another example embodiment, a lighting fixture structure for recessed installation in a sloped ceiling includes a light source and a housing. The housing includes a can having an opening, wherein light from the light source is emitted out of the can through the opening. The housing also includes a can top attached to the can. The can top and the opening are at opposite ends of the can. The can and the can top define a cavity of the housing. A front section of the can and a rear section of the can are each skewed between the opening and the can top.

In another example embodiment, a housing for a recessed lighting fixture includes a can having an opening for passage of light out of the can. The housing further includes a can top attached to the can. The can top and the opening are at opposite ends of the can. The can and the can top define a cavity of the housing. A front section of the can includes a first plurality of flat segments that are joined such that the front section is skewed between the opening and the can top. A rear section of the can includes a second plurality of flat segments that are joined such that the rear section is skewed between the opening and the can top.

These and other aspects, objects, features, and embodiments will be apparent from the following description and the claims.

### BRIEF DESCRIPTION OF THE FIGURES

Reference will now be made to the accompanying drawings, which are not necessarily drawn to scale, and wherein:

FIG. 1 illustrates a lighting fixture structure including a skewed housing according to an example embodiment;

FIGS. 2A and 2B illustrate a vertical cross-section of the lighting fixture structure 100 including the housing 102 of FIG. 1 according to an example embodiment;

FIG. 3 illustrates an exploded view of a housing of the lighting fixture structure of FIG. 1 according to an example embodiment;

FIG. 4 illustrates an exploded view of a housing of the lighting fixture structure of FIG. 1 according to another example embodiment;

FIG. 5 illustrates an exploded view of a housing of the lighting fixture structure of FIG. 1 according to another example embodiment; and

FIG. 6 illustrates a vertical cross-section of the lighting fixture structure 100 including the housing 102 of FIG. 1 according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DESCRIPTION OF EXAMPLE EMBODIMENTS

In the following paragraphs, particular embodiments will be described in further detail by way of example with reference to the figures. In the description, well known components, methods, and/or processing techniques are omitted or briefly described. Furthermore, reference to various feature(s) of the embodiments is not to suggest that all embodiments must include the referenced feature(s).

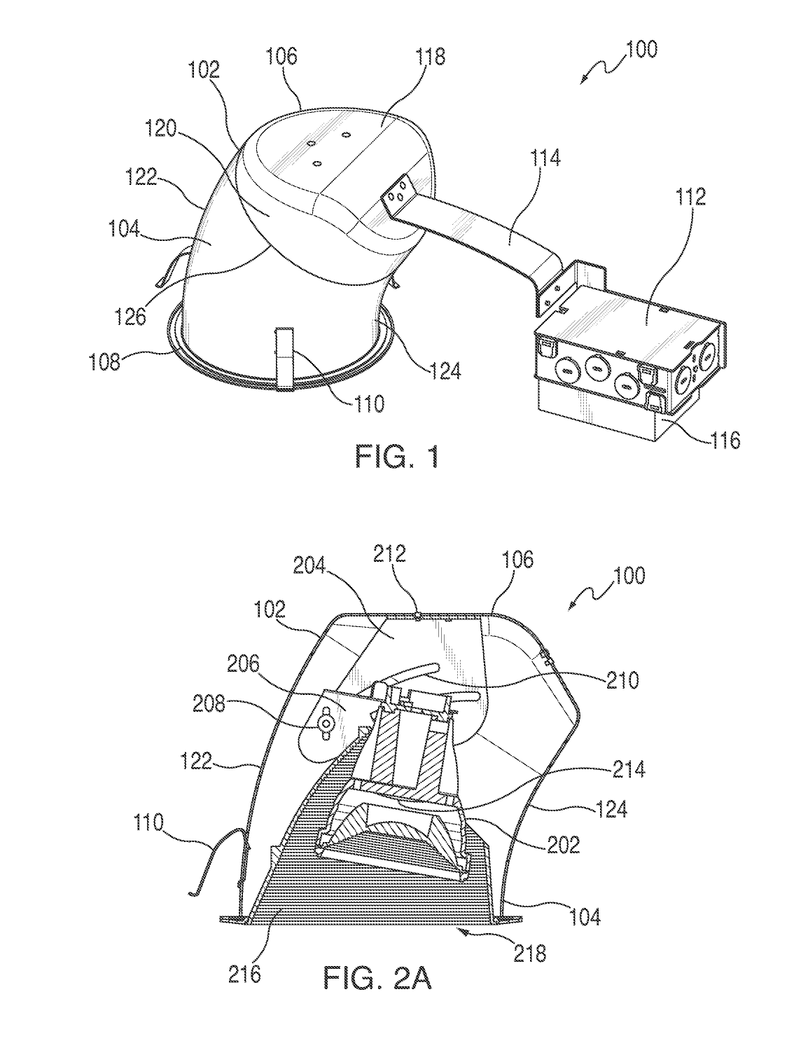

Turning now to the drawings, FIG. 1 illustrates a lighting fixture structure 100 including a skewed housing 102 according to an example embodiment. The lighting fixture structure 100 includes the housing 102, a junction box 112, and an arm 114 extending between the housing 102 and the junction box 112. In some example embodiments, a driver 116 may be attached to the junction box 112 as shown in FIG. 1 to provide power to one or more light sources (e.g., incandescent or LED light sources) that are in a cavity of the housing 102. For example, wiring connections may be inside the junction box 112.

The housing 102 includes a can 104 and a can top 106. The can top 106 is attached to the can 104 at a top end of the can 104. The can 104 and the can top 106 define a cavity of the housing 102. The housing 102 may also include a flange 108 that may be abutted below and against a sloped ceiling when the housing 102 is recessed in the ceiling.

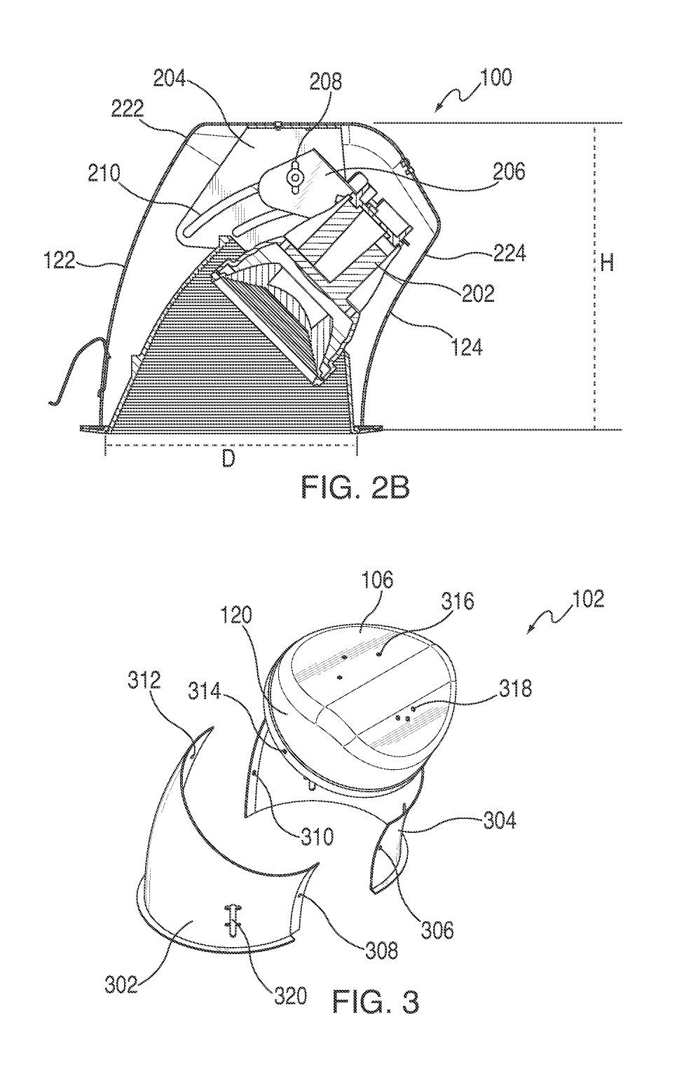

In some example embodiments, the skewed housing 102 is a curved housing. To illustrate, the can 104 may be a curved can. For example, the can 104 includes a front section 122 and a rear section 124, where the front section 122 and the rear section 124 may be curved. To illustrate, the can 104 includes an opening (shown opening 218 in FIG. 2A). The opening and the can top 106 are at opposite ends of the can 104. The front section 122 and the rear section 124 are each curved between the opening and the can top 106. In some example embodiments, the front section 122 and the rear section 124 may be concentric. To illustrate, a curvature of the front section 122 between the opening and the can top 106 and a curvature of the rear section 124 between the opening and the can top 106 may be concentric. Alternatively, the can 104 may be wider at the opening 218 than at the top end of the can 104.

In some example embodiments, the front section 122 may be longer than the rear section 122. To illustrate, an edge 126 of the can 104 may slope down from the front section 122 to the rear section 124 when the housing 104 is positioned such that the flange 108 is in a horizontal plane. In some example embodiments, the can 104 may have a circular cross section. For example, the can 104 may have a curved cylindrical shape, where the can 104 is curved as the can 104 extends from one opening of the can 104 to the opposite opening of the can 104.

In some example embodiments, the can top 106 may include a top section 118 and a side section 120. For example, the top section 118 may be substantially parallel to a surface that is below the housing 102 when the housing 102 is recessed in a sloped ceiling. In some example embodiments, the side section 120 of the cap top 106 may be attached to the can 104. The can top 106 may also include a front section that has substantially the same curvature as the front section 122 of the can 104. Alternatively, the front section of the top section 120 may be flat section that is attached to the can 104. The can top 106 may also include a rear section that has substantially the same curvature as the rear section 124 of the can 104. Alternatively, the rear section of the top section 120 may be flat section that is attached to the can 104. In some example embodiments, the rear section of the side section 120 may be longer than the front section of the side section 120.

In some example embodiments, the arm 114 may be attached to the top section 118 of the can top 106. For example, the arm 114 may be attached to the top section 118 of the can top 106 such that the junction box 112, which is attached to an opposite end of the arm 114, is positioned above a ceiling when the housing 102 is recessed behind the ceiling. In some alternative embodiments, the arm 114 may be attached to another section of the housing 102 without departing from the scope of this disclosure. For example, the arm 114 may be attached to the side section 120 of the can top 106 above the rear section 124 of the can 104.

In some example embodiments, the lighting fixture structure 100 may also include retention structures 110 to mount the housing 102 behind a structure such as a sloped ceiling. The retention structure 110 may each extend through a corresponding opening in the can 104 from within the can 104 such that the retention structures 110 rest on the back side of a ceiling when the housing is recessed behind the ceiling. In some alternative embodiments, the housing 102 may be retained behind a ceiling using means other than the retention structures 110.

As explained in more detail below, when lighting fixture structure 100 is recessed behind a sloped ceiling, the shape of the housing 102 allows a light source disposed inside the cavity of the housing 102 to be oriented to emit light symmetrically around a vertical axis extending between the light source and a floor that is below a sloped ceiling.

In some example embodiments, the housing 102 may be made from sheet metal. Alternatively, the housing 102 may be made from another suitable material as may be contemplated by those of ordinary skill in the art with the benefit of this disclosure. Although the arm 114 is shown in FIG. 1 attached to a sloped portion of the top section 118, in some alternative embodiments, the arm 114 may be attached to another section of the top section 118. In some example embodiments, the side section 120 of the can top 106 may be longer or shorter than shown in FIG. 1. Further, the can top 106 may have a shape other than shown in FIG. 1 without departing from the scope of this disclosure.

FIGS. 2A and 2B illustrate a vertical cross-section of the lighting fixture structure 100 including the housing 102 of FIG. 1 according to an example embodiment. As illustrated in FIGS. 2A and 2B, a light source 202 is disposed inside a cavity 216 of the housing 102. The light source 202 may include one or more light sources 214. For example, the light source 202 may include LED, CFL, HID, and/or incandescent sources.

In some example embodiments, the can top 106 may include a front section 222 that has substantially the same curvature as the front section 122 of the can 104. The can top 106 may also include a rear section 224 that has substantially the same curvature as the rear section 124 of the can 104. In some alternative embodiments, one or both of the front section 222 and the rear section 224 may be a flat section.

As shown in FIGS. 2A and 2B, the light source 202 may be positioned in different positions within the cavity 216 of the housing 102. For example, the light source 202 may be positioned as shown in FIG. 2A for recess installation of the housing 102 in a ceiling with a 2/12 pitch (i.e., a sloped ceiling that is sloped approximately 10 degrees relative to a horizontal plane). The light source 202 may also be moved to the position shown in FIG. 2B for recess installation of the housing 102 in a ceiling with a 12/12 pitch (i.e., a sloped ceiling that is sloped approximately 45 degrees relative to a horizontal plane). The light source 202 may be moved to other positioned between the two positions shown in FIGS. 2A and 2B for recessing the housing 102 in a ceiling that has between 2/12 and 12/12 pitch.

To illustrate, a mounting bracket 204 may be attached to the can top 106 for securing the light source 202 inside the housing 102. For example, one or more fasteners 212 (e.g., rivets or screws) may be used to attach the mounting bracket 204 to the can top 106. The light source 202 may be attached to a receiver bracket 206 within the cavity 216, and the receiver bracket 206 may be moveably attached to the mounting bracket 204. To illustrate, the receiver bracket 206 may be moveably attached to the mounting bracket 204 by one or more coupling devices 208, such as a screw/pin and a bolt, that extend through one or more arcuate slots 210 of the mounting bracket 204. The position of the light source 202 may be adjusted by moving the receiver bracket 206 relative to the mounting bracket 204. For example, the one or more coupling devices 208 may be moved along the one or more arcuate slots 210 to change the position of the receiver bracket 206 relative to the mounting bracket 204. To illustrate, the coupling device 208 may be loosened or tightened as needed to move or fix in position the receiver bracket 206 relative to the mounting bracket 204. Because the light source 202 is attached to the receiver bracket 206 to move along with the receiver bracket 206, the position of the light source 202 may be changed by moving the receiver bracket 206.

The housing 102 may be recessed in a sloped ceiling to provide illumination to a surface that is below the sloped ceiling. For example, light from the light source 202 may be emitted through the opening 218 of the can 104 (i.e., the opening of the housing 102). To orient the light source 202 vertically down toward a surface that is below the sloped ceiling, the position of the light source 202 may be adjusted by moving the receiver bracket 206 relative to the mounting bracket 204. For example, the housing 102 may be recessed in a sloped ceiling that is sloped at an angle between approximately 10 degrees (i.e., 2/12 pitch) and approximately 45 degrees (i.e., 12/12 pitch) and allow the light source 202 to be oriented vertically down toward a surface (i.e., in a direction that is perpendicular to a surface) that is below the sloped ceiling. In some example embodiments, the height H of the housing 102 may be approximately 7 inches, and the diameter of the opening 218 may be approximately 6 inches. For example, the housing 102 may be inserted through an opening of a ceiling that has a diameter of approximately 6.5 inches.

Because the can 104 of the housing 12 is curved, the housing 102 may be recessed in a sloped ceiling without requiring a ceiling opening that is significantly larger than the diameter of the opening of the housing 102. For example, the lighting fixture structure 100 or just the housing 102 may be used during in remodeling projects. To illustrate, the housing 102 may be used as a replacement for an existing recessed lighting fixture housing. Further, the housing 102 may be recessed in a sloped ceiling that has a pitch in a range of 2/12 to 12/12, and allow the light source 202 to provide illumination to a horizontal surface (e.g., a floor) below the sloped ceiling, where the illumination is symmetrical with respect to a vertical axis that is perpendicular to the horizontal surface. Further, because the housing 102 has a cylindrical profile from the opening 218 to the can top 106, the housing 102 may be easily recessed through a round opening of a ceiling as opposed to requiring an elliptical opening.

Although the light source 202 is attached to the housing 102 using the mounting bracket 204 and the receiving bracket 206, in some example embodiments, light source 202 may be attached to the housing 102 using one or more other structures without departing from the scope of this disclosure. Further, the mounting bracket 204 may be attached to the housing 102 at a different location than shown in FIGS. 2A and 2B without departing from the scope of this disclosure.

FIG. 3 illustrates an exploded view of the housing 102 of the lighting fixture structure 100 of FIG. 1 according to an example embodiment. As shown in FIG. 3, the housing 102 shown in FIG. 1 may be assembled from the can top 106, a first can segment 302, and a second can segment 304 that can each be made separately. In some example embodiments, deep drawn stamping, hydroforming, and/or die casting may be used to make the housing 102. To illustrate, the can top 106, the first can segment 302, and the second can segment 304 may each be made, for example, as a deep drawn stamping part, a hydroformed part, or a die cast part. In some example embodiments, apertures 306, 308, 310, 312 may be used to attach the first can segment 302 with the second can segment 304 using, for example, rivets to assemble the can 104 shown in FIG. 1.

In some example embodiments, the can top 106 may be attached to the assembled can 104 using one or more apertures 314 on the side section 120 of the can top 106. The can top 106 may also include fastener openings 316 for attaching, for example, the mounting bracket 204 (shown in FIG. 2A) using fasteners. The can top 106 may also include fastener openings 318 for attaching the arm 114 (shown in FIG. 1) to the can top 106 using fasteners.

As shown in FIG. 3, the housing 102 may include openings 320 for inserting a respective retention bracket (e.g., the retention bracket 110 shown in FIG. 1) to retain the housing 102 recessed behind a ceiling.

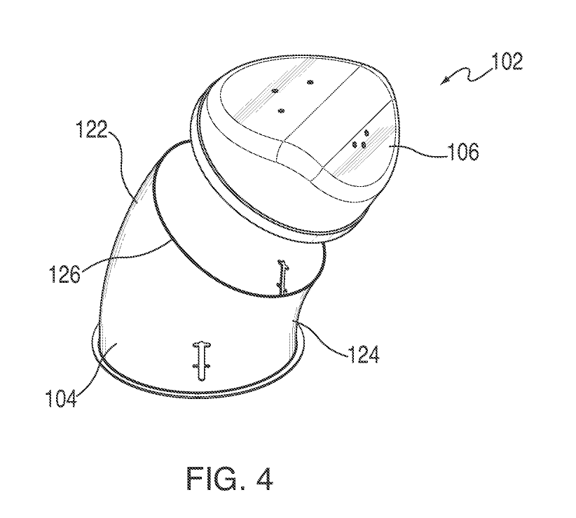

Although the particular apertures/opening are shown in FIG. 3 for attachment of the components of the housing 102, in alternative embodiments, fewer or more apertures/opening than shown and/or apertures/openings that are in a different location may be used. Further, means other than some or all of the apertures/openings shown in FIG. 4 may be used to assemble the housing 102.

FIG. 4 illustrates an exploded view of the housing 102 of the lighting fixture structure 100 of FIG. 1 according to another example embodiment. As shown in FIG. 4, the housing 102 shown in FIG. 1 may be assembled from the can 104 and the can top 106 that are made separately. The can 104 and the can top 106 may each be made using one or more of the methods described with respect to FIG. 3. To illustrate, deep drawn stamping, hydroforming, and/or die casting may be used to make the housing 102. In some example embodiments, each of can 104 and the can top 106 may be made from sheet metal. As illustrated in FIG. 3, the can 104 may be made such that the rear section 124 is shorter than the front section 122 while having the same curvature, where the can has a circular cross-section.

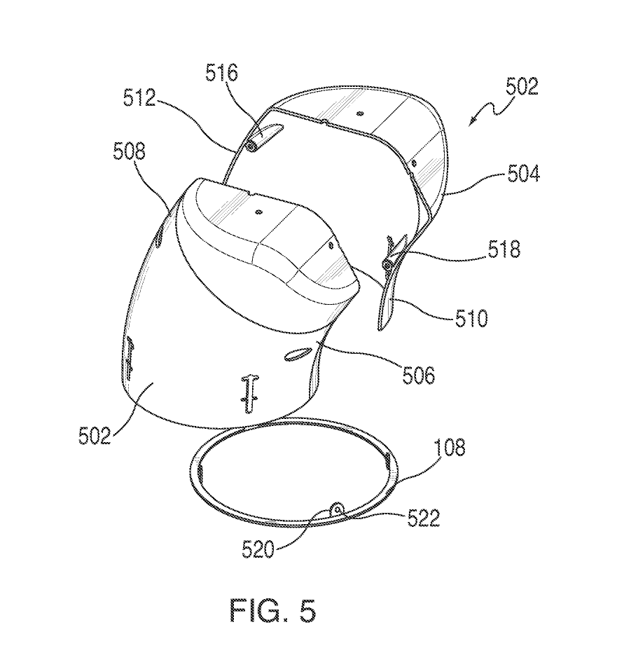

FIG. 5 illustrates an exploded view of a housing 502 of the lighting fixture structure 100 of FIG. 1 according to another example embodiment. As shown in FIG. 5, the housing 502 may be assembled from a first housing segment 502 and a second housing segment 504. Each housing segment 502, 504 includes a portion of the can 104 and a portion of the can top 106 shown in FIG. 1. The housing segments 502, 504 may be coupled to each other using fasteners (e.g., screws) and fastener receptors 516, 518 to form the housing 502.

As shown in FIG. 5, the housing segment 502 has a curved rear section 506 and a curved front section 508. Similarly, the housing segment 504 has a curved rear section 510 and a curved front section 512. When the housing segments 502, 504 are attached to each other to form the housing 502, the curved rear sections 506, 510 define the rear section 124 of the housing 102 corresponding to the rear section 124 of the housing 102 shown in FIG. 1, and the curved front sections 508, 512 define the front section 122 of the housing 102 corresponding to the front section 122 of the housing 102 shown in FIG. 1.

In some example embodiments, the flange 108 may be made separately and attached to the housing segments 502, 504 using fasteners (e.g., rivets or screws) that extend through openings 522 formed in protrusions 520 of the flange 108. The housing segments 502, 504 and the flange 108 may each be made using one or more of the methods described with respect to FIG. 3. For example, the housing segments 502, 504 may be made as deep drawn stamping parts, hydroformed parts, or die cast parts.

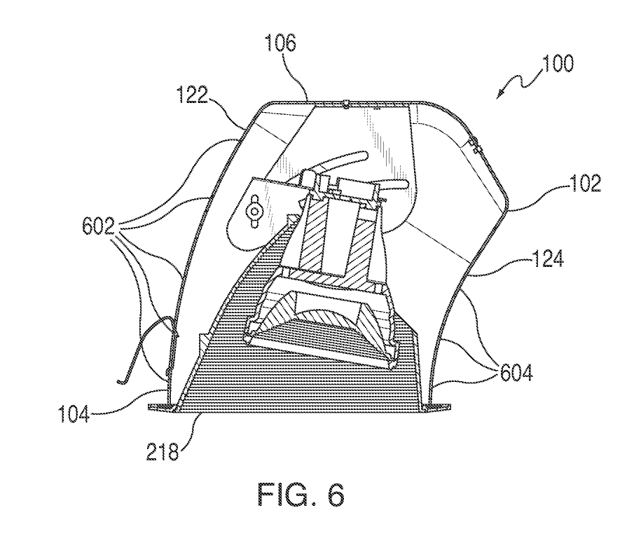

FIG. 6 illustrates a vertical cross-section of the lighting fixture structure 100 including the skewed housing 102 of FIG. 1 according to another example embodiment. In some example embodiments, the front section 122 of the can 104 may include a multiple segments 602. For example, some or all of the multiple segments 602 may be flat segments. The multiple segments 602 may be joined such that the front section 122 is skewed between the opening 218 of the can 104 and the can top 106.

In some example embodiments, the rear section 124 of the can 104 may also include multiple segments 228. For example, some or all of the multiple segments 604 may be flat segments. The multiple segments 604 may be joined such that the rear section 124 is skewed between the opening 218 of the can 104 and the can top 106.

Although particular embodiments have been described herein, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. A housing for a recessed lighting fixture, comprising:
a can having an opening for passage of light out of the can; and
a can top attached to the can, wherein the can top and the opening are at opposite ends of the can, wherein the can and the can top define a cavity of the housing, and wherein a front section of the can and a rear section of the can are each skewed between the opening and the can top.

2. The housing of claim 1, wherein the can top includes a top section for attaching a mounting bracket within the cavity of the housing, wherein the top section is substantially parallel to a surface that is below the housing when the housing is recessed in a sloped ceiling.

3. The housing of claim 2, wherein the can top includes a side section that is attached to can and wherein the side section extends down from the top section of the can top.

4. The housing of claim 1, wherein a curvature of the front section between the opening and the can top and a curvature of the rear section between the opening and the can top are concentric.

5. The housing of claim 1, wherein the rear section is shorter than the front section.

6. The housing of claim 1, wherein the housing is designed for recessed installation in a sloped ceiling that has a pitch within a range of 2/12 to 12/12.

7. The housing of claim 1, wherein the can includes a first can segment and a second can segment, wherein the first can segment and the second can segment are joined together to form the can.

8. The housing of claim 7, wherein the can top is attached to both the first can segment and the second can segment of the can.

9. The housing of claim 1, wherein the can has a circular cross section at the opening and wherein the can has a second cross section that is within the circular cross section between the opening and the can top.

10. A lighting fixture structure for recessed installation in a sloped ceiling, the lighting fixture structure comprising:
a light source; and
a housing comprising:
a can having an opening, wherein light from the light source is emitted out of the can through the opening; and
a can top attached to the can, wherein the can top and the opening are at opposite ends of the can, wherein the can and the can top define a cavity of the housing, and wherein a front section of the can and a rear section of the can are each skewed between the opening and the can top.

11. The lighting fixture structure of claim 10, wherein a curvature of the front section between the opening and the can top and a curvature of the rear section between the opening and the can top are concentric.

12. The lighting fixture structure of claim 10, wherein the rear section is shorter than the front section.

13. The lighting fixture structure of claim 10, wherein the housing is designed for recessed installation in a sloped ceiling that has a pitch within a range of 2/12 to 12/12.

14. The lighting fixture structure of claim 10, further comprising a junction box, wherein the junction box is attached to the housing by an arm extending between the junction box and the housing.

15. The lighting fixture structure of claim 10, further including a mounting bracket disposed within the cavity of the housing, wherein the mounting bracket is used for mounting the light source within the housing and wherein the mounting bracket is attached to the housing.

16. The lighting fixture structure of claim 15, wherein the mounting bracket is adjustable to change a direction of the light emitted by the light source.

17. The lighting fixture structure of claim 15, wherein the mounting bracket is attached to the housing.

18. A housing for a recessed lighting fixture, comprising:
a can having an opening for passage of light out of the can; and
a can top attached to the can, wherein the can top and the opening are at opposite ends of the can, wherein the can and the can top define a cavity of the housing, wherein a front section of the can includes a first plurality of flat segments that are joined such that the front section is skewed between the opening and the can top, and wherein a rear section of the can includes a second plurality of flat segments that are joined such that the rear section is skewed between the opening and the can top.

19. The housing of claim 18, wherein the can top includes a top section for attaching a mounting bracket within the cavity of the housing, wherein the top section is substantially parallel to a surface that is below the housing when the housing is recessed in a sloped ceiling.

20. The housing of claim 18, wherein the rear section is shorter than the front section.
